(19) United States
(12) Patent Application Publication
(10) Pub. No.: US 2004/0203431 A1
(43) Pub. Date: Oct. 14, 2004

(54) Method and apparatus for determining the topology of a hybrid-fiber coaxial cable plant

(76) Inventor: Michael Jaimie Cooper, Marietta, GA (US)

Correspondence Address: MICHAEL JAIMIE COOPER, 3402 CRANBORNE CHASE, MARIETTA, GA, 30062, US

(21) Appl. No.: 10/255,417

(22) Filed: Sep. 26, 2002

(51) Int. Cl. H04B 17/00

(52) U.S. Cl. 455/67.11; 455/3.06; 455/423

(57) ABSTRACT

A topology discovery technique for automatically determining the network structure of a hybrid fiber coax or all coax cable plant is disclosed. The resulting topology is structured in terms of fiber nodes, amplifiers, and taps. The location of customer devices such as cable modems, set-top boxes, and telephony terminal adapters are identified within the resulting topology. The discovery technique relies on measurements made only at the headend location of the cable plant.

### FIELD OF THE INVENTION

The invention relates, in general, to Radio Frequency (RF) communications networks and, more specifically, to an apparatus and method for automatically determining the architecture or network topology of a hybrid-fiber coaxial cable plant when used as a bi-directional communications network, where the architectural determination is based on measurements at a single location in the system, namely the head-end, and does not necessitate distributed measurements or measurement devices.

### BACKGROUND OF THE INVENTION

In the interest of expanding their revenue stream, traditional cable television (CATV) companies have expanded their product offerings from the video-only distribution services of yesterday to now include such things as broadband data access, video on demand (VOD), and even telephony. This expansion in services has required that cable companies upgrade their plant capabilities from the one-way (commonly all coax) systems to more modern two-way hybrid fiber coaxial (HFC) architectures. Further, in the past, cable companies have chosen very passive techniques to maintain and monitor plant integrity. Such techniques included assuming that the plant and signal quality to every customer was adequate unless a customer called and lodged a complaint. In addition, while the customer may not have been pleased, they were at least tolerant of loosing their broadcast television services for several hours while a technician researched and remedied the problem.

Diagnosing and solving these reported problems was not trivial as the technician had very little information relative to geographical location of the source and overall impacts. For example, a common approach to diagnostics was given the address of the complaining customer, the technician would review a set of Computer Aided Design (CAD) schematics representing the plant lay-down and make some educated guesses based upon past experience and plant performance about what/where the source of the problem might be. Further, the accuracy of these plant schematics was questionalble as implementation rarely matched initial design and the drawings were not updated in a timely manner to reflect any differences. At this point, the technician was forced to get into a truck and physically travel to suspect places to make measurements and further refine his hypothesis until the problem source was identified, basically a trial-and-error methodology which relied on significant insight into the past performance and characterization of the plant.

While this approach may have been adequate for traditional one-way video distribution services, where customers might tolerate an outage of several hours or more in which they couldn't watch their television, services such as telephony and even broadband data access (especially for business) are not nearly as tolerant, as down-time for these users can mean the difference in significant sums of money or even life and death. Further, competitors in the telephony industry, namely the traditional bells, have set a high standard of 99.999% service availability which customers have come to expect. Any less is viewed as a substandard product offering which is not able to compete in the market place.

Another factor that contributes to the difficulty in diagnosing issues is the fact that the operational support systems, which include billing, network management, the call center, and plant engineering, are not commonly integrated into one cohesive information system. That is to say, cable companies do not currently have the capability to automatically simultaneously view both their HFC cable plant architecture and the customer performance metrics in an integrated fashion. Common practice requires that the call center provide the street address for a customer complaint for which the technician can open CAD drawings of the plant to make educated guess about where to begin the diagnostics process. This process adds to the down time and certainly makes a proactive monitoring system extremely difficult. This disconnect in information systems further prevents the call center from responding with positive feedback concerning solution status to any other callers lodging later complaints as a result of the same breakdown. Existing systems which identify particular customer locations relative to plant architectures are manually built via a CAD program and subject to the errors associated with human data entry.

An automated system is required that can derive the network diagram or topology of an HFC cable plant architecture and automatically place customers onto this topology mapping. Such a system removes the possibility of error from the data entry process and supports a proactive approach to plant characterization by allowing the collection of performance metrics within the system and the associated correlation of those metrics to specific plant locations or segments. Such collection systems allow an operator to identify and repair issues before they manifest themselves as problems for a customer, thus allowing an operator to be proactive in plant diagnostics and management.

### SUMMARY OF THE INVENTION

The methodology disclosed in the present invention can best be described as a network topology discovery algorithm whereby each customer communications device is isolated relative to its location within the HFC cable plant and relative to other customer devices. As shown in FIG. 1, a CATV network is a hybrid network, which is composed of a general tree and branch architecture composed of optical fiber trunk lines and coaxial cable trunk and feeder lines. The network may also be composed of only coaxial cables. Optical fibers serve to increase the network coverage areas but they are not critical to the disclosed invention.

By measuring several unique parameters for each customer device, this invention is able to isolate the topology of the plant architecture and further place each customer device within that topology. Key parameters required for this invention include:

1) Either two-way or one-way total propagation delay between the customer site and the head-end;

2) Either:

a. The change in the return-path propagation delay experienced as a result of changing the upstream channel frequency from a position near the center of the pass region of the return-path low pass filter to a position near the cut-off frequency of the low pass filter. (Specifically characterizing the group delay resulting near the cut-off frequency of the return amplifiers.), or

b. The change in return-path received power experienced as a result of changing the upstream channel frequency from a position near the center of the pass region of the return-path low pass filter to a position near the cut-off frequency of the low pass filter. (Specifically characterizing the attenuation behavior near the cut-off frequency of the return amplifiers), and

3) The customer device transmit power level required to achieve a nominal input level at the headend receiver.

By measuring these three parameters and applying basic clustering algorithms, the invention is able to automatically resolve the location of a given customer premises device relative to specific fiber node, amplifier depth, and tap location. One very valuable aspect to this invention is the fact that the Data Over Cable System Interface Specification (DOCSIS) facilitates the measurement of each of these parameters. DOCSIS is the cable industry's standard for providing communications over HFC infrastructures and forms the basis for other standards including PacketCable which serves as a means for providing Voice over Internet Protocol (VoIP) services over cable infrastructure. DOCSIS specifies requirements for several standard devices which include cable modems which are customer communications devices and Cable Modem Termination Systems (CMTSs) which are devices which reside at a central (headend) location and serve to provide the interface between the HFC network and more traditional Internet Protocol (IP) based networks. The CMTS typically services thousands of cable modems. The measurements and processes defined in this invention may be implemented quite easily within the DOCSIS standard as each parameter is required in the Management Information Base (MIB) as defined by the DOCSIS Operations Support System Interface (OSSI) Specification.

### BRIEF DESCRIPTION OF THE DRAWINGS

The present invention can be more easily understood and the further advantages and uses thereof more readily apparent, when considered in view of the description of the preferred embodiments and the following figures in which:

FIG. 1 is a diagram illustrating the general architecture of a hybrid fiber coaxial cable communication system in accordance with the present invention;

FIG. 2 is an illustration of the amplitude or magnitude response of a typical low pass filter commonly associated with the return-path amplifier of an HFC cable plant;

FIG. 3 is an illustration of the group delay response of a typical low pass filter commonly associated with the return-path amplifier of an HFC cable plant;

FIGS. 4 and 5 are flowcharts implementing the teachings of the present invention;

FIG. 6 is an illustration of the relationship between the change in signal propagation delay (DELTA_TIME) and the total delay (TD1) in accordance with the present invention;

FIG. 7 is an illustration of the relationship between the change in signal amplitude attenuation (DELTA_POWER) and the total delay (TD1) in accordance with the present invention;

FIG. 8 is an expanded view of the relationship between the change in signal propagation delay (DELTA_TIME) and total delay (TD1);

FIG. 9 is an illustration of the relationship between the tap location as numbered from the headend and the terminal device upstream transmit level in accordance with the present invention; and

FIG. 10 is an example illustration of the topological mapping output associated with the present invention.

### DETAILED DESCRIPTION OF THE PREFERRED EMBODIMENTS

As discussed above, there remains a need for a method and apparatus to provide for the automatic and adaptive discovery of the network topology of a HFC cable plant. In addition, it is desirable to automatically discover and map both existing and new terminal devices onto this discovered HFC topology. The terminal devices could include such devices as cable modems, cable set-top boxes, and telephony terminal adapters. One possible approach to address this need is to deploy packet sniffing devices within the HFC cable plant that would “sniff” packets and by deciphering device addresses could resolve the location of devices within the plant. However, such an approach incurs a series penalty in that both cost and fidelity of architectural discovery are factors directly correlated to the number of sniffing devices deployed. Therefore, a more desirable solution would not require the cost and maintenance of physical devices throughout the plant. The present invention provides such a solution by allowing topological discovery via a software-based implementation which leverages easily measured metrics at the headend of the plant. The fact that such metrics are already required by the existing industry standard protocol (DOCSIS) for passing data over HFC cable networks makes realization of such an invention quite easy. Further, the apparatus and method of the present invention automatically and accurately adapts to the dynamics of a cable plant environment, namely the addition, deletion, and movement of terminal devices.

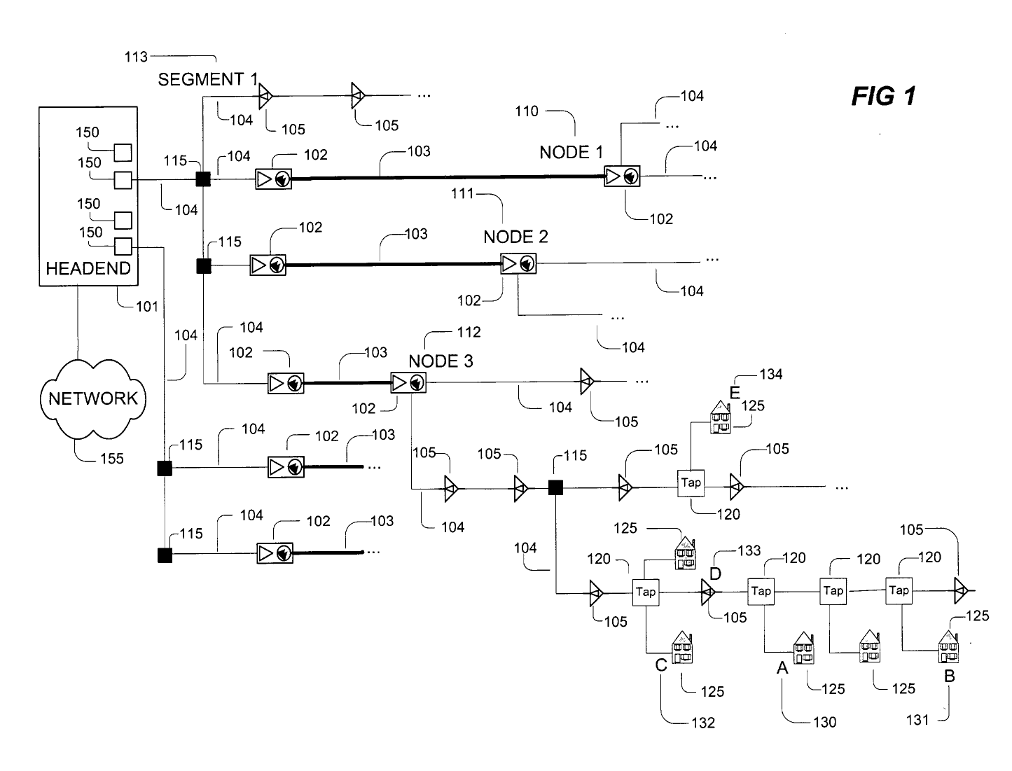

FIG. 1 is a block diagram illustrating the general architecture of a HFC cable communication system in accordance with the present invention. A headend 101 resides in a central location and supports the services for thousands of terminal devices 125 located in or next to customer subscriber homes. In between the headend 101 and the terminal devices 125 is a cable plant which exhibits a common tree and branch structure. The cable plant generally consists of optical transceivers 102, fiber 103, coaxial cable 104, amplifiers 105, splitter/combiners 115, and taps 120. More modern cable plants support bidirectional communications meaning that information may be passed from the headend 101 to the terminal devices 125 in the home, commonly referred to as the downstream direction, and from the terminal device 125 to the headend 101, commonly referred to as the upstream or return path.

Cable plants have traditionally been used to distribute video signals to customers in the way of cable television. As a result, plants have been historically designed with downstream communications as the primary goal. It has only been in recent years with the deployment of data and telephony services that the return path has been implemented. Bandwidth allocation has progressed with this evolution with the early deployment of video distribution resulting in the downstream occupying the greatest portion of frequency spectrum, generally in the frequency range of 80 MHz to 1000 MHz, and the more modern return path only occupying from 5 MHz to 65 MHz.

One common characteristic of transmitting RF signals is that generally the higher the signal frequency one tries to transmit, the greater the power loss per unit of cable length. As a result, cable plants are designed to provide adequate downstream signal level at each terminal device 125 for the highest frequency that the plant is to propagate. For example, if the cable operator is planning to transmit signals up to 550 MHz, then he might expect such a signal to propagate 2100 feet before requiring downstream reamplification. Thus, the physical distance between consecutive amplifiers 105 would be 2100 feet. For cable plants which support higher frequencies, the distance between consecutive amplifiers 105 would be shorter. Similarly, cable plants supporting only lower frequencies could yield amplifier 105 spacing farther apart.

One interesting side effect of this design, is that houses that are closer to an amplifier “D” 133 such as house “A” 130 would receive a much stronger downstream signal than another house “B” 131 which is farther from that same amplifier “D” 133. As a result, the signal propagated to house “A” 130 must be intentionally attenuated so as to prevent the signal from saturating the receiver. This compensation, in the form of attenuation, is achieved by utilizing different taps 120 which result in different attenuations. Higher loss (greater attenuation) taps 120 are utilized for locations closer to amplifier “D” 133 (such as house “A” 130); lower loss taps 120 are utilized for homes serviced by longer cable runs (such as “B” 131). An interesting by product of such a configuration is that since the return path frequencies are extremely low, below 65 MHz, their loss as a result of cable propagation is much less. Generally, the headend 101 receiver is designed to accept a nominal input power level. The primary factor affecting the transmit power level that a terminal device 125 must use to achieve this nominal input power level at the headend 101 is the level needed to compensate for the tap 120 loss. Specifically, terminal devices 125 which are located closer to an amplifier 105 must transmit at a higher power level to compensate for the larger tap 120 loss which is incurred to compensate for the downstream signal propagation. Similarly, a terminal device 125 which is located farthest from an amplifier 105 will be connected to a lower tap 120 and as such will not need to transmit with as much power to achieve communications with the headend 101. This is not intuitive as one would expect terminal devices 125 which are father from the headend 101 would need to transmit at a higher power level than those located closer to the headend 101.

Propagation through fiber 103 is not nearly as lossy as signal propagation through the same length of coaxial cabling 104. As a result, modern cable plant designs utilize fiber to propagate a signal into a general physical area or neighborhood as illustrated by Node 1 110, Node 2 111, and Node 3 112, before the signal is converted to electrical and distributed through the coaxial cable 104 and amplifier 105 network. Whereas the spacing between amplifiers is generally uniform and a function of maximum downstream frequency, the length of fiber 103 tends to vary more as it is more directly correlated to the distance between the headend 101 and the general neighborhood where the signal is required.

As illustrated in FIG. 1, several optical transceivers 102 may be combined 115 near the headend. The headend 101 is comprised of multiple transceiver modules 150 that are generally designed to service a specified number of terminal adapters 125. If a given node, Node 1 110 for example, does not currently service enough terminal adapters, then combining multiple nodes results in a more economical use of the expensive transceivers 150 at the headend. Generally, market penetration will increase over time and as a result the number of terminal adapters serviced by a single node will increase. The cable operator will then seek to decombine some of these nodes. For example, the operator might want to decombine Node 1 110, Node 2 111, and Node 3 112 so as to yield a specific number of terminal adapters for each transceiver 150. In order to achieve such a result, the operator would need to know the number of terminal adapters serviced by each fiber 103.

The headend 101 may also be coupled to a network 155, which may include the Internet, online services, telephone and cable television networks, and other communications systems. The network 155 is not a required element of the invention, as the inventive concepts can be employed over any general RF communications medium.

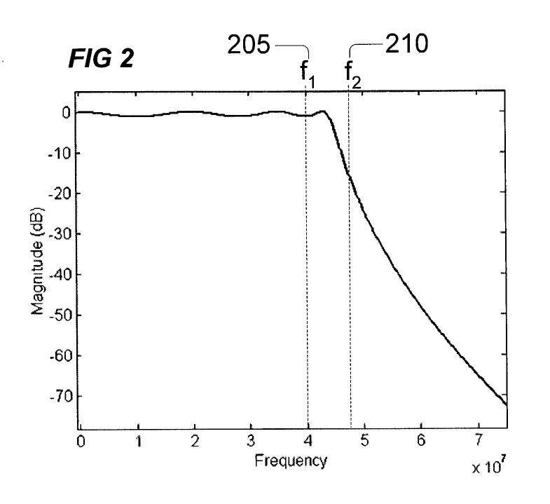

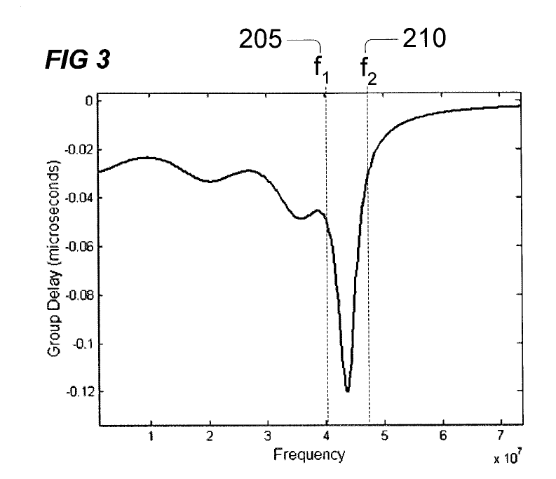

FIGS. 2 and 3 illustrate the magnitude and group delay response respectively of a filter present in the general amplifier 105. As illustrated in FIG. 1, an amplifier 105 is actually two amplifiers, one which increases the signal strength of downstream propagating signals and one that increases the signal strength of upstream (return path) signals. The illustrations in FIGS. 2 and 3 are representative of those one would see for an upstream or return path amplifier. The signal strength is amplified uniformly as shown in FIG. 2 for signals below the pass frequency (f₁ 205), where f₁ 205 is typically in the 42 MHz range for United States (US) cable plant designs and 65 MHz for European plant designs. At frequencies above the stop frequency of the amplifier (f₂ 210), the signals are attenuated significantly as illustrated in FIG. 2. The characteristics of the amplifier between the pass frequency (f₁ 205) and the stop frequency (f₂ 210), including both gain and group delay, exhibit a great deal of variation from device to device,. The group delay refers the time delay affects versus frequency of a propagating signal, i.e. some frequencies may pass through the amplifier faster than other frequencies. Thus, while all amplifiers in the plant will perform almost identically at frequencies well below the pass frequency (f₁ 205) and well above the stop frequency (f₂ 210), the transition region between (f₁ 205) and (f₂ 210) and even at frequencies near these two points usually vary from amplifier to amplifier.

The invention as described up to this point, including FIGS. 1-3, has focused on general characteristics of a hybrid fiber coax cable plant and is readily known to those practicing in the art of HFC plant design and maintenance. The invention described herein seeks to exploit three key qualities of these HFC plant characteristics, namely: 1) electrical and optical signals require time to propagate a finite distance down a fiber or electrical cable and the time to propagate is directly proportional to the distance for the type of medium that is being traversed, 2) all amplifiers exhibit unique amplitude and group delay responses and these unique characteristics are most distinguishing at frequencies near or between the pass frequency (f₁ 205) and stop frequency (f₂ 210) of the amplifier, and 3) terminal devices located closer to an amplifier must transmit a stronger signal than those terminal devices further from the amplifier in order to overcome the greater tap loss.

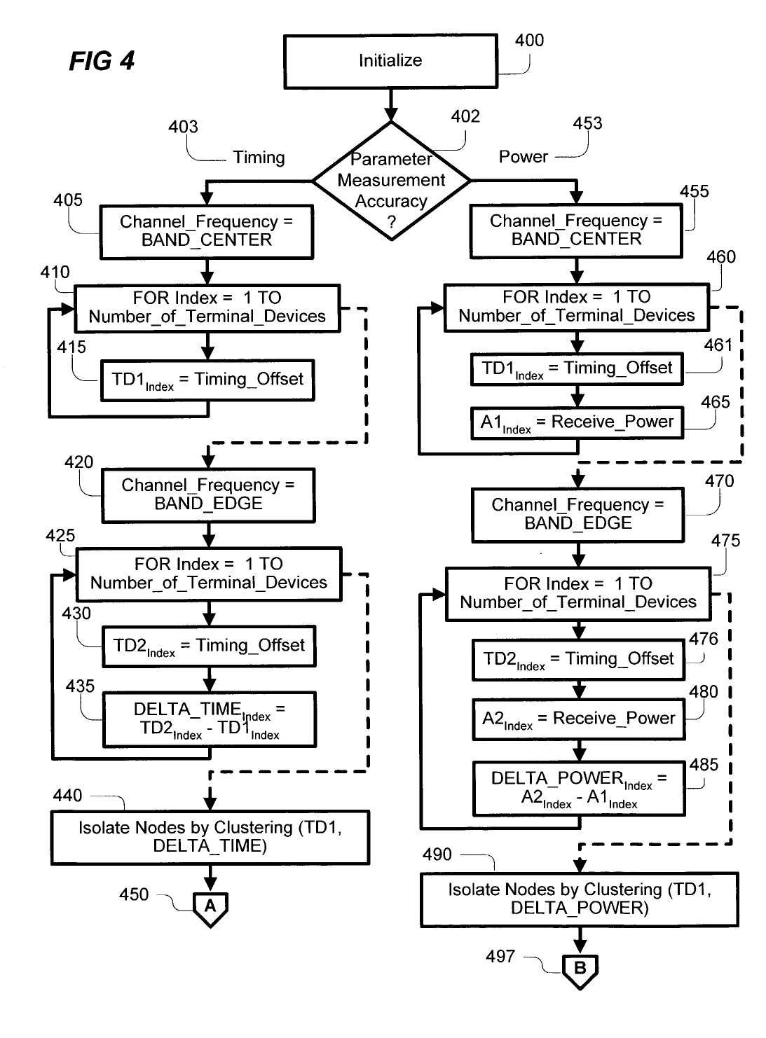

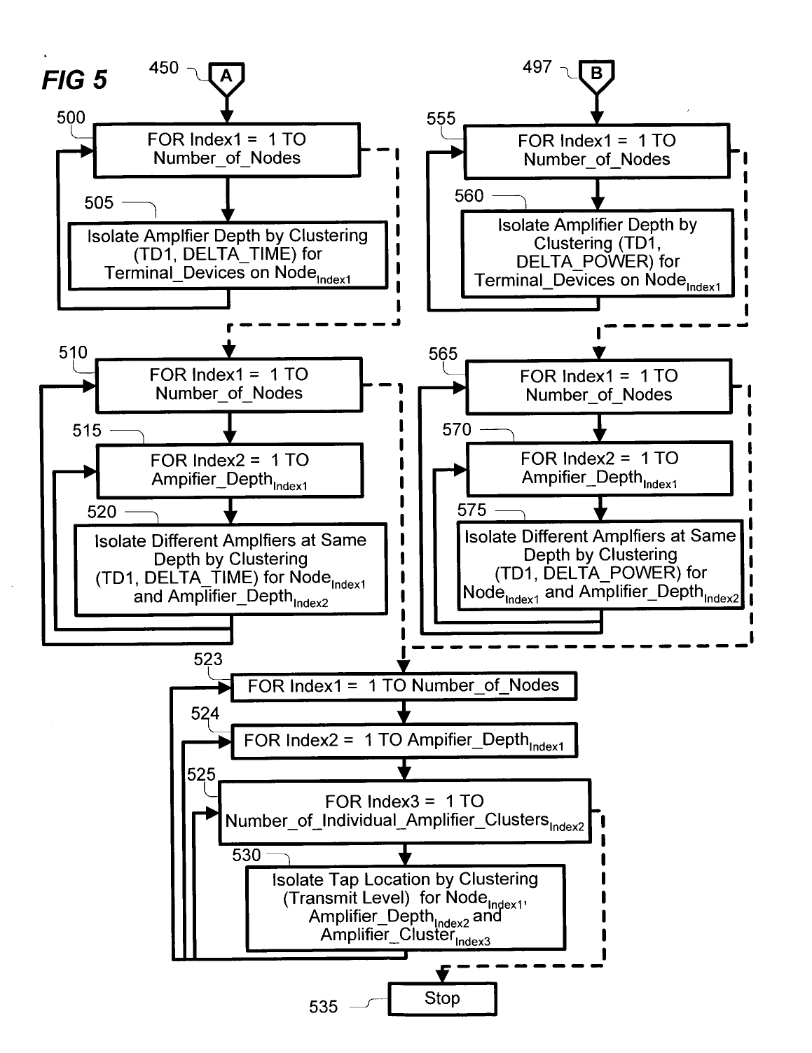

FIGS. 4 and 5 illustrate a process according to the teachings of the present invention for establishing the network topology of an HFC cable plant. The process begins at an initialization step 400 and proceeds to a step 402 where an assessment of the capabilities of the headend measurement accuracy is made. Headends which can accurately measure timing relationships would select the path indicated as Timing 403. Similarly, headends which provide highly accurate power measurements would select the path indicated as Power 453. Referring back to a headend which provides accurate timing measurements, the process would move from step 402 to step 405 where the return path operating frequency (channel that the terminal devices are using to transmit to the headend) is moved to a location near or below the center of the return path operating region. For example, most HFC cable plants in the US operate in the region of 5 to 42 MHz, so this step would result in the active return-path channel being set to a frequency in the range of 15 to 25 MHz. Except for the fact that the lower edge of the operating region (i.e., near 5 MHz) can also commonly exhibit symptoms of increased group delay, this initial channel frequency would be set to the lower band edge. The exact choice for a channel frequency is not critical as what the process is trying to characterize is the change in group delay relative to a change in frequency. The process then moves to step 410 where a loop is established in which the signal propagation time delay (TD1_{Index}) step 415 is measured for each terminal device on the HFC network. Steps 410 and 415 form the basis of the loop, and step 415 is exercised for each terminal device.

Following the loop (steps 410-415), the process then moves to a step 420 where a new operating channel frequency is selected. The new channel frequency is selected near the edge of the pass frequency (f₁ 205) of the amplifiers. The goal is to select a frequency which will produce the greatest delay when compared to the original BAND_CENTER operating frequency. Generally, the higher the operating frequency, the greater the group delay. For most US based HFC cable plants, this frequency would be near 42 MHz, although since amplifiers in series produce additive group delay affects, it may not be possible to establish a communications link in the presence of significant amounts of group delay. As a result, a frequency below 42 MHz may be required. For European based HFC cable plants, this frequency would be near 65 MHz, although similar issues may necessitate a frequency slightly lower. The process then moves to step 425 where a loop is established in which the signal propagation time delay (TD2_{Index}) step 430 is measured for each terminal device on the HFC network. The process then calculates the change in propagation time delay (DELTA_TIME) in step 435. The change in propagation time delay is equal to the difference between the propagation delay measured at the BAND_EDGE and the propagation delay measured at the BAND_CENTER. Steps 425, 430, and 435 form the basis of the loop, and steps 430, and 435 are exercised for each terminal device on the HFC cable plant.

The signal propagation time delay (TD1_{Index} and TD2_{Index}) may be defined in several ways including both one way and round trip. For example in the case of a one way definition, the propagation time delay would be defined as the time it takes the signal to propagate from the terminal device to the headend, or alternately in a round trip definition, as the time to propagate from the headend to a terminal device and then from the terminal device back to the headend. As long as a consistent definition is used, the benefits of this invention may be realized since ultimately it is the change in the propagation delay due to the group delay affects of the amplifiers which are critical to the invention, and any bias resulting from a single measurement is removed by computing the difference.

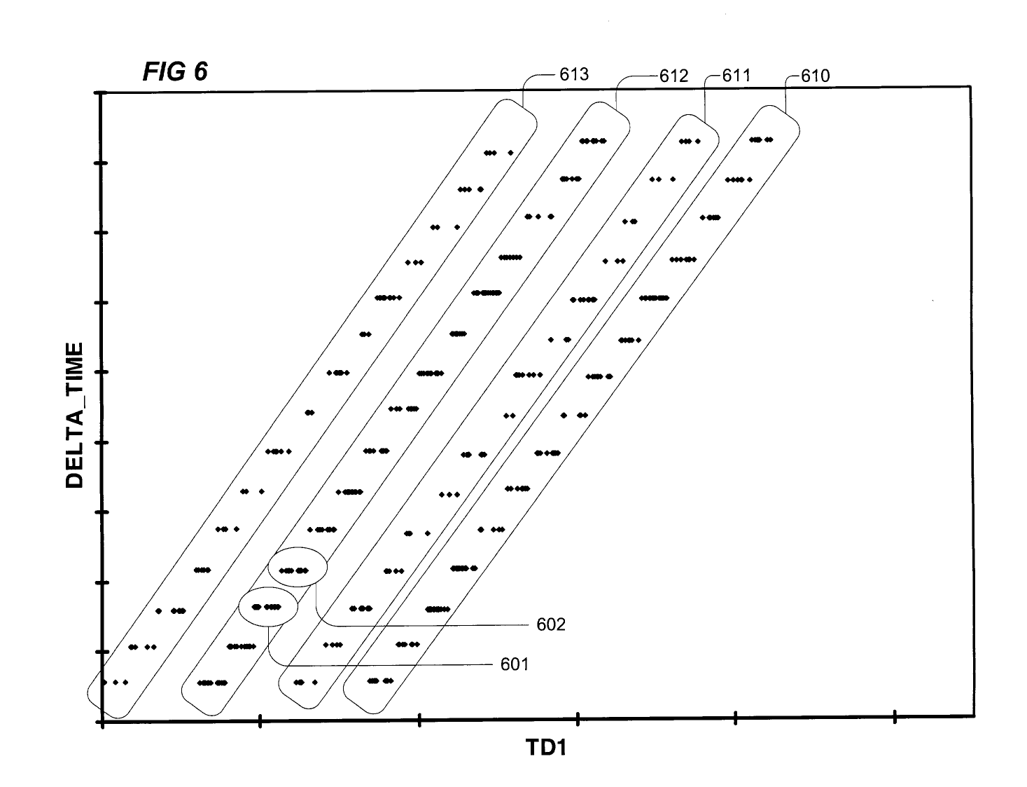

Upon exiting the loop (steps 425-435), the invention now has a significant amount of information needed to determine the network diagram or topology. Specifically, if one were to plot on a Cartesian graph the relationship (abscissa, ordinate)=(TD1_{Index}, DELTA_TIME _{Index}) for each terminal device, one would see a graph similar to that illustrated in FIG. 6. The groupings given by 610, 611, 612, and 613 represent terminal devices on fiber Node 1 (110), Node 2 (111), Node 3 (112), and Segment 1 (113) of FIG. 1 respectively. TD2 may be substituted for TD1 as the abscissa to yield similar results. Similarly, groupings given as 601 in FIG. 6 represent terminal devices located three amplifiers deep from fiber Node 3 (612). Terminal device “C” 132 shown in FIG. 1 is one example of such a device. Groupings given as 602 in FIG. 6 represent terminal devices located four amplifiers deep from fiber Node 3 (612). Terminal devices “A” 130 and “B” 131 shown in FIG. 1 are examples of such devices.

Returning to FIG. 4, the next step in the process following the current loop (steps 425-435) is to apply clustering algorithms to the measured terminal device data (TD1_{Index}, DELTA_TIME _{Index}) as indicated in step 440. Clustering algorithms are well understood by those practicing in the art and are documented under the general topics of “clustering” and “multivariate data analysis”. One such text is Clustering of Large Data Sets by Jure Zupan, John Wiley and Sons, New York, 1982. The result of step 440 is the isolation of all terminal adapters located on each individual Node. Following step 440, the process moves from FIG. 4 to FIG. 5 via tab A 450.

Following step 440, the process then establishes a new loop in step 500. This loop isolates the clusters of terminal adapters based on the amplifier depth at which they are located. This is accomplished by the application of clustering algorithms to the measured terminal device data (TD1_{Index}, DELTA_TIME _{Index}) as indicated in step 505; however the parameters utilized in application of the clustering algorithm are more strict which allows the isolation of the amplifier depth groupings. Steps 500 and 505 form the basis of this loop, and step 505 is exercised for each node clustering identified in step 440.

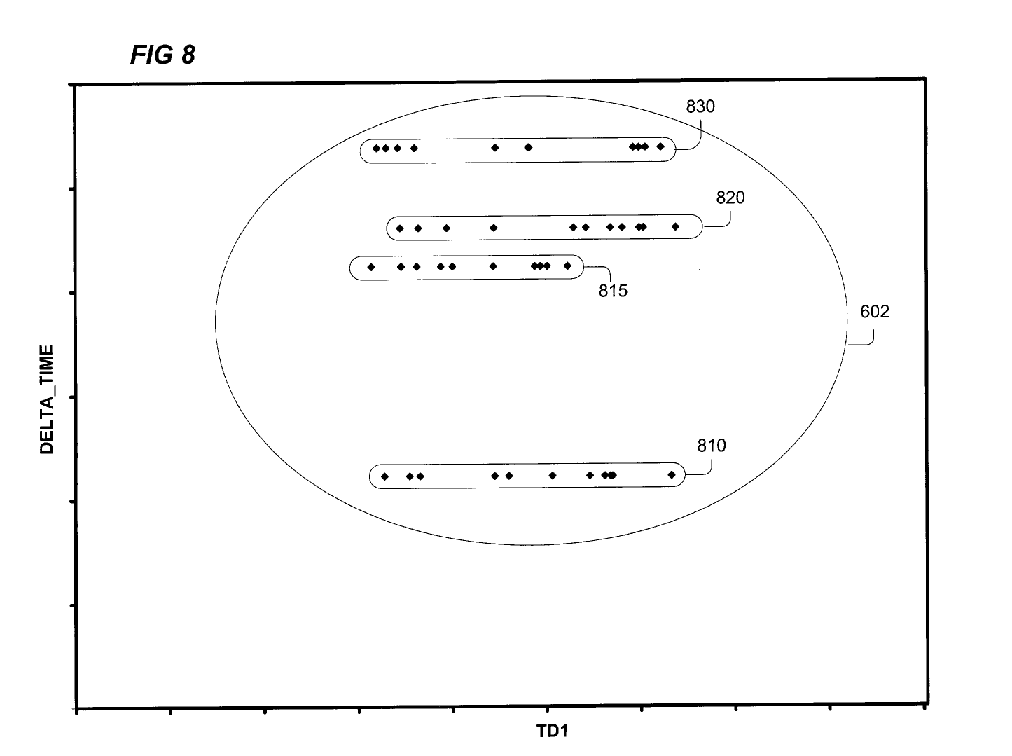

The invention has now isolated terminal devices within the HFC cable plant topology to unique fiber nodes as well as to specific amplifier depths on those nodes. The next step it to isolate the terminal devices to a unique amplifier sequence at a given depth. Referring back to FIG. 6, if one were to “zoom” in on cluster 602 (or any other amplifier depth cluster illustrated in FIG. 6), the result would be similar to that shown in FIG. 8. Specifically, one amplifier depth for a single node is actually multiple clusters. Four clusters are illustrated in FIG. 8 (810, 815, 820, 830). Each of these clusters (810, 815, 820, 830) actually correspond to a different sequence of three amplifiers. Referring back to FIG. 1, both terminal devices “C” 132 and “E” 134 represent devices that are three amplifiers deep on Node 3 but not the same three amplifiers and therefore would be present within different clusters of FIG. 8.

Following the loop identified in steps 500 and 505, the process then establishes a nested loop structure whereby for each node clustering (step 510) and for each amplifier depth clustering for a given node (step 515), clustering algorithms are applied to the measured terminal device data (TD1_{Index}, DELTA_TIME _{Index}) as indicated in step 520. The application of clustering in step 520 is the isolation of all the terminal adapters which pass through the same sequence of amplifiers on the cable plant. Steps 510, 515, and 520 form the basis of this loop, and step 520 is exercised for every node clustering identified in step 440 and for each amplifier depth identified in step 505.

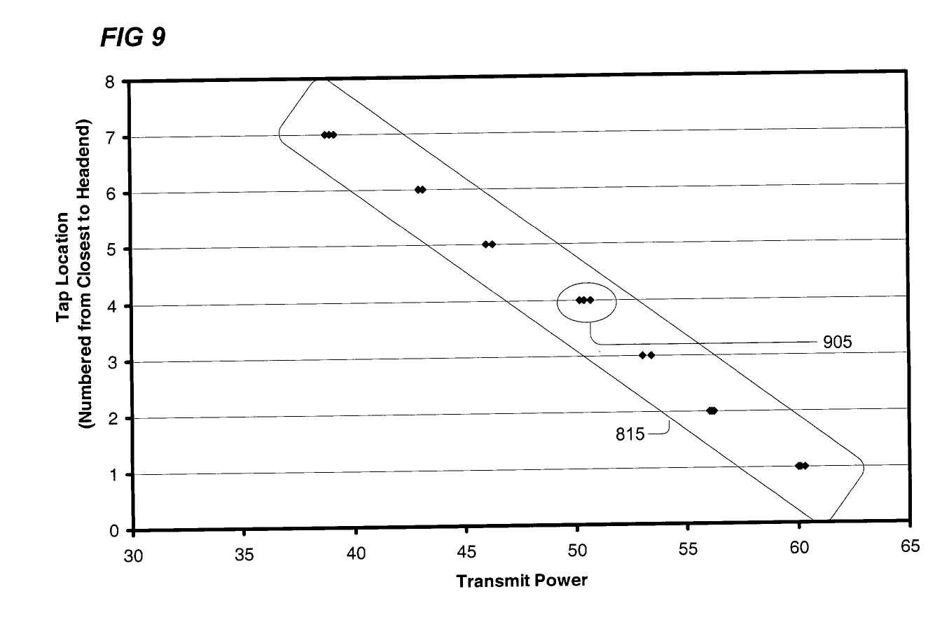

Following completion of the loop identified in steps 510-520, the process then moves to a step 523 where a final double nested loop is established. The steps identified in this final loop are best explained with an illustration. FIG. 9 illustrates the relationship between the tap location (as numbered with increasing distance from the headend) and the terminal adapter upstream transmit power. Specifically, the return path transmit level required by each terminal adapter would cluster around the level required to compensate for the tap loss. Any variations as a result of longer/shorter cable runs are minimal as the loss per foot at the lower frequencies of the upstream are minimal. For example, cluster 905 provides the grouping for one transmit level which would represent tap 4 for the amplifier identified as 815 in FIG. 8.

The processes identified in this last loop seek to isolate (for each node identified (step 523), for each amplifier depth identified (step 524), and for each unique amplifier sequence identified (step 525)) the unique tap locations that each terminal device is located on (step 530). This is accomplished by applying a one-dimensional clustering algorithm to the terminal device return path transmit level. Steps 523, 524, 525, and 530 form the basis for this loop and step 530 is exercised for every node clustering identified in step 440, for each amplifier depth identified in step 505, and each unique amplifier sequence identified in step 520. Following completion of the loop identified in steps 523, 524, 525, and 530, this invention has now isolated all terminal adapters to their specific node, amplifier depth, unique amplifier sequence, and tap location. The process then moves to a final step 535 which terminates the process. It should be noted that rather than using transmit power level to isolate tap location (steps 523-530), a process could be designed to utilize the propagation delay (TD1 or TD2); however, this is a suboptimal solution as the exact locations are more likely to be ambiguous between adjacent taps as the length of wiring runs inside these homes can be very unpredictable.

Steps 405-450 and 500-520 provided the steps required for this-invention when utilizing a timing oriented approach. Referring back to FIG. 4 step 402, if power (453) was selected as the optimum measurement parameter, then the process would move from step 402 to a step 455 whereby the return path operating frequency is selected to be near the center of the return path operating region. The process actually used to select this frequency is similar to that used in step 405; however, since the magnitude response of a filter (shown in FIG. 2) is even more uniform than group delay (shown in FIG. 3) over the pass region of the filter, selection of the BAND_CENTER operating frequency is even less critical and can generally fall between 15 and 30 MHz for most US based cable plants, and 15 to 40 MHz for European cable plants.

Following establishment of the return path channel frequency in step 455, the process then moves to step 460 where a loop is established in which the signal propagation time delay (TD1_{Index}) step 461 and the received signal power (A1_{Index}) step 465 is measured for each terminal device on the HFC network. Steps 460, 461 and 465 form the basis of the loop, and steps 461 and 465 are exercised for each terminal device.

Following the loop (steps 460-465), the process then moves to a step 470 where a new operating channel frequency is selected. The new channel frequency is selected near the edge of the pass frequency (f₁ 205) of the amplifiers. The goal is to select a frequency which will produce the greatest amplitude attenuation when compared to the original BAND_CENTER operating frequency. Generally, the attenuation is greatest for the highest operating frequency. For most US based HFC cable plants, this frequency would be near 42 MHz, although since amplifiers in series produce multiplicative attenuation affects, it may not be possible to establish a communications link in the presence of significant amounts of attenuation. As a result, a frequency below 42 MHz may be required. For European based HFC cable plants, this frequency would be near 65 MHz, although similar issues may necessitate a frequency slightly lower. The process then moves to step 475 where a loop is established in which the signal propagation time delay (TD2_{Index}) step 476 and the receive signal power (A₂_{Index}) step 480 is measured for each terminal device on the HFC network. The process then calculates the change in received signal power (DELTA_POWER) in step 485. The change in received signal power is equal to the difference between the received signal power measured at the BAND_EDGE and the received signal power measured at the BAND_CENTER. Steps 475, 476, 480, and 485 form the basis of the loop, and steps 476, 480, and 485 are exercised for each terminal device on the HFC cable plant.

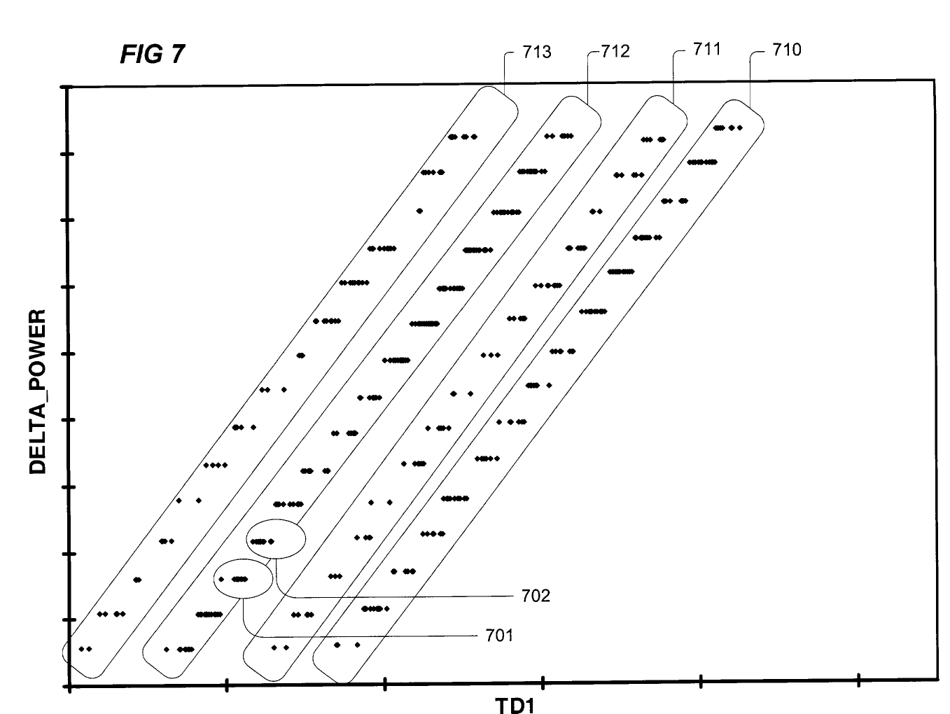

Upon exiting the loop (steps 475-485), the invention now has a significant amount of information needed to determine the network diagram or topology. Specifically, if one were to plot on a Cartesian graph the relationship (abscissa, ordinate)=(TD1_{Index}, DELTA_POWER _{Index}) for each terminal device, one would see a graph similar to that illustrated in FIG. 7. The groupings given by 710, 711, 712, and 713 represent terminal devices on fiber Node 1 (110), Node 2 (111), Node 3 (112), and Segment 1 (113) of FIG. 1 respectively. TD2 may be substituted for TD1 as the abscissa to yield similar results. Similarly, groupings given as 701 in FIG. 7 represent terminal devices located three amplifiers deep from fiber Node 3 (712). Terminal device “C” 132 shown in FIG. 1 is one example of such a device. Groupings given as 702 in FIG. 7 represent terminal devices located four amplifiers deep from fiber Node 3 (712). Terminal devices “A” 130 and “B” 131 shown in FIG. 1 are examples of such devices.

Returning to FIG. 4, the next step in the process following the current loop (steps 475-485) is to apply clustering algorithms to the measured terminal device data (TD1_{Index}, DELTA_POWER _{Index}) as indicated in step 490. The result of step 490 is the isolation of all terminal adapters located on each individual Node. Following step 490, the process moves from FIG. 4 to FIG. 5 via tab B 497.

Following step 490, the process then establishes a new loop in step 555. This loop isolates the clusters of terminal adapters based on the amplifier depth at which they are located. This is accomplished by the application of clustering algorithms to the measured terminal device data (TD1_{Index}, DELTA_POWER _{Index}) as indicated in step 560; however the parameters utilized in application of the clustering algorithm here are more strict which allows the isolation of the amplifier depth groupings. Steps 555 and 560 form the basis of this loop, and step 560 is exercised for each node clustering identified in step 490.

The invention has now isolated terminal devices within the HFC cable plant topology to unique fiber nodes as well as to specific amplifier depths on those nodes. The next step it to isolate the terminal devices to a unique amplifier sequence at a given depth. Referring back to FIG. 7, if one were to “zoom” in on cluster 702 (or any other cluster illustrated in FIG. 7), the result would demonstate a similar relationship as was illustrated between FIGS. 6 and FIG. 8, namely, one amplifier depth for a single node is actually multiple clusters. Four clusters are illustrated in FIG. 8 (810, 815, 820, 830).

Following the loop identified in steps 555 and 560, the process then establishes a nested loop structure whereby for each node clustering (step 565) and for each amplifier depth clustering for a given node (step 570), clustering algorithms are applied to the measured terminal device data (TD1_{Index}, DELTA_POWER _{Index}) as indicated in step 575. The application of clustering in step 575 is the isolation of all the terminal adapters which pass through the same sequence of amplifiers on the cable plant. Steps 565, 570, and 575 form the basis of this loop, and step 575 is exercised for every node clustering identified in step 490 and for each amplifier depth identified in step 560.

Following completion of the loop identified in steps 565-575, the process then returns to a step 523 where a final double nested loop is established to identify the tap location of each terminal adapter.

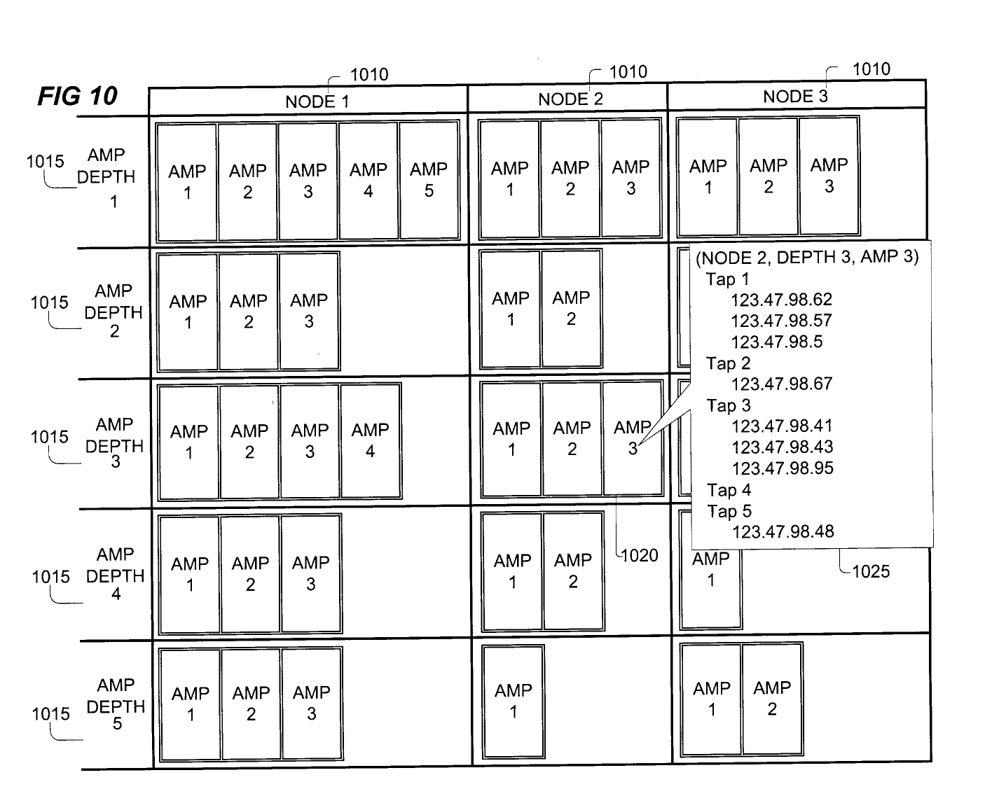

In summary, the preferred embodiment of this invention has identified a set of unique measurements and a series of processing steps which may be exercised to identify the HFC plant topology or architecture in terms of key devices, namely fiber nodes, amplifiers, and taps. FIG. 10 provides an example of how this information might be provided to a cable operator in order to support drilling down and understanding the cable plant. Specifically, nodes might be identified as columns 1010 and amplifier depths as rows 1015. The columns 1010 represent those clusterings identified in steps 440 or 490 of FIG. 4. The rows 1015 represent those amplifier depths identified in steps 505 and 560. For each unique column 1010 and row 1015, the specific amplifiers (identified in steps 520 or 575) may be identified (1020). Selection of any of these specific amplifiers (1025) would yield a listing of the taps and those terminal adapters connected to the specific tap. Note, IP addresses are shown in FIG. 10 as an example only. Other methods of identifying the terminal adapter, such as MAC address or device serial number could also be utilized.

While the invention has been described with reference to a preferred embodiment, it will be understood by those skilled in the art that various changes may be made and equivalent elements may be substituted for elements thereof without departing from the scope of the present invention. In addition, modifications may be made to adapt the teachings of the invention to a particular situation without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for adaptively determining the network topology of a Radio Frequency (RF) communications network, wherein the network topology includes communications components, said method comprising:
(a) determining at least one statistical metric of a communications signal between a network device and the headend on at least two different RF communication channels; and
(b) establishing groupings of one or more devices based on the statistical metric as measured on each of the RF communication channels.

2. The method of claim 1 wherein the communications components include fiber nodes, amplifiers, taps, and terminal network devices.

3. The method of claim 1 wherein the statistical metric is the one-way propagation delay representing the time to traverse the cable between the terminal device and the headend.

4. The method of claim 1 wherein the statistical metric is the two-way propagation delay representing the time to traverse the cable between the headend and the terminal device.

5. The method of claim 1 wherein the statistical metric is the headend received signal power level.

6. The method of claim 1 wherein step (a) comprises determining a first statistical metric representing the change in group delay experienced on the RF network as a result of changing the frequency of the communications channel from a first frequency to a second frequency.

7. The method of claim 1 wherein step (b) comprises the application of clustering algorithms to the parameters of signal propagation delay and change in group delay.

8. The method of claim 7 wherein each cluster identified represents the terminal network devices on the cable network belonging to a unique fiber node on the cable plant.

9. The method of claim 7 wherein each cluster identified represents the terminal network devices on the cable network belonging to a unique amplifier depth and a particular fiber node on the cable plant.

10. The method of claim 7 wherein each cluster identified represents the terminal network devices on the cable network belonging to a unique sequence of amplifiers at a particular amplifier depth and on a unique fiber node of the cable plant.

11. The method of claim 1 wherein step (a) comprises determining a first statistical metric representing the change in attenuation experienced on the RF network as a result of changing the frequency of the communications channel from a first frequency to a second frequency.

12. The method of claim 1 wherein step (b) comprises the application of clustering algorithms to the parameters of signal propagation delay and change in signal attenuation.

13. The method of claim 12 wherein each cluster identified represents the terminal network devices on the cable network belonging to a unique fiber node on the cable plant.

14. The method of claim 12 wherein each cluster identified represents the terminal network devices on the cable network belonging to a unique amplifier depth and a particular fiber node on the cable plant.

15. The method of claim 12 wherein each cluster identified represents the terminal network devices on the cable network belonging to a unique sequence of amplifiers at a particular amplifier depth and on a unique fiber node on the cable plant.

16. A method for adaptively determining the tap location within a network topology of an RF communications network, said method comprising:
(a) determining the terminal network device transmit power level required to provide a nominal input signal level at the headend; and
(b) applying clustering algorithms to the parameter: terminal network device transmit power level.

17. The method of claim 16 wherein each cluster identified represents the terminal network devices on the cable network belonging to a unique tap location on the cable plant.

18. An article of manufacture comprising:
a computer program product comprising a computer-usable medium having a computer-readable code therein for adaptively determining the network topology of a Radio Frequency (RF) communications network, said article of manufacturer comprising:
a computer-readable program code module for determining the number of fiber nodes combined at the headend of an RF communications network;
a computer-readable program code module for determining the specific network terminal devices present on each fiber node;
a computer-readable program code module for determining the specific network terminal devices present at each specific amplifier depth;
a computer-readable program code module for determining the specific network terminal devices present on each unique amplifier sequence at a specific amplifier depth; and
a computer-readable program code module for determining the specific network terminal devices present at each tap location for a specific amplifier sequence.
